(19) United States
(12) Patent Application Publication
(10) Pub. No.: US 2005/0194564 A1
(43) Pub. Date: Sep. 8, 2005

(54) Titanium stripping solution

(75) Inventors: Yasuji Fujita, Tokyo (JP); Takashi Nozaki, Tokyo (JP); Yoshihiro Ishino, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MELTEX INC., Tokyo (JP)

(21) Appl. No.: 11/045,310

(22) Filed: Jan. 31, 2005

(30) Foreign Application Priority Data
Feb. 23, 2004 (JP) 2004-045779

(51) Int. Cl. C09K 13/00

(52) U.S. Cl. 252/79.1; 252/79.3

(57) ABSTRACT

A titanium stripping solution comprises an aqueous solution of pH 5 or lower containing a fluorine compound and a metal ion having a reducing power, which enables etching of titanium at a high etching rate by the fluorine compound with exhibiting an effect of suppressing corrosion of other metal(s).

### BACKGROUND OF THE INVENTION

The present invention relates to a titanium stripping solution, more particularly a titanium stripping solution for stripping a titanium thin film formed on a wafer, an element, or the like.

Recently, with advancement of performance of electronic parts and miniaturization thereof, the methods for mounting semiconductor chips have been advanced from connection by wire bonding to connection by wireless bonding capable of high-density mounting. Among them, there has been increasingly widely used a high-density mounting method (flip chip mounting method) wherein protruded electrodes called bumps are formed on electrodes on the surfaces of the semiconductor chips, the chips are reversed, and they are connected by face down bonding so that the bumps may abut on a substrate. The material for the above bumps is, for example, a solder alloy or gold and a metal layer called an under barrier metal (UBM) is provided between the bump and the electrode on the surface of the semiconductor chip. The UBM is provided in order to enhance adherence between the electrode and the bump and also in order to prevent diffusion of metals between the electrode and the bump. Usually, the UBM has a monolayer structure or laminated layer structure of titanium, nickel, copper, chromium, alloys thereof, and/or the like.

The UBM as mentioned above is, for example, formed by plating or formed by etching after film formation by spattering. Moreover, there is a case that, after film formation, bumps are formed and then the UBM is formed by etching using the bumps as a mask. At etching in the step of forming the UBM comprising a monolayer structure of titanium or a laminated structure of titanium with other metal(s), a fluorine-based chemical solution can be used as a titanium stripping solution (Japanese Patent Application Laid-Open No. 2002-146562).

However, conventional titanium stripping solutions have been rendered acidic so as to enable etching of titanium. Therefore, in the case that the bumps are formed with a solder alloy, tin, or the like, tin is particularly dissolved by the acidic titanium stripping solution to induce corrosion of the bumps. In the state that the bumps are thus corroded and irregularity is formed on the bump surface, the composition of the bumps is changed and hence variation in melting temperature thereof occurs, whereby face down bonding is disturbed in some cases. When heating temperature in face down bonding is set high in order to avoid it, there arises a problem that the semiconductor chips are damaged.

### SUMMARY OF THE INVENTION

The present invention has been accomplished in view of the above situation and an object thereof is to provide a titanium stripping solution capable of removing a titanium thin film at a high etching rate with suppressing corrosion of other metal(s).

For achieving such an object, the present invention has a constitution wherein the titanium stripping solution is an aqueous solution of pH 5 or lower containing a fluorine compound and a metal ion having a reducing power.

A preferred embodiment of the invention has a constitution wherein the concentration of the metal ion is 0.02 g/L or more.

A preferred embodiment of the invention has a constitution wherein the metal ion is any ion of trivalent titanium or divalent iron.

A preferred embodiment of the invention has a constitution wherein the content of the fluorine compound is within the range of 1 to 270 g/L in terms of fluorine.

A preferred embodiment of the invention has a constitution wherein the titanium stripping solution contains a copper corrosion inhibitor.

According to the present invention as mentioned above, since the fluorine compound constituting the titanium stripping solution etches titanium and also the metal ion having a reducing power contained in the titanium stripping solution suppresses corrosion of other metal(s), it becomes possible to remove the titanium thin film with achieving a high etching rate for titanium and with suppressing corrosion of other metal(s) such as a solder alloy, tin, or the like.

### DESCRIPTION OF PREFERRED EMBODIMENTS

The titanium stripping solution of the present invention contains a fluorine compound and a metal ion having a reducing power in an aqueous solution of pH 5 or lower. In such a titanium stripping solution of the present invention, the fluorine compound etches titanium at a high etching rate and also the metal ion having a reducing power exhibits an action of suppressing corrosion of other metal(s) by the fluorine compound.

The concentration of the metal ion having a reducing power in the titanium stripping solution of the invention is 0.02 g/L or more, preferably in the range of 0.05 to 5 g/L. When the concentration of the metal ion having a reducing power is less than 0.02 g/L, the corrosion of other metal(s) by the fluorine compound cannot be suppressed. In the case that the concentration exceeds 5 g/L, further improvement of the corrosion-suppressing effect cannot be obtained, the fluorine compound becomes in a saturated state in the titanium stripping solution, and the etching rate of titanium is decreased. Thus, the cases are not preferable. In this connection, the metal ion having a reducing power to be incorporated into the titanium stripping solution is gradually oxidized in the air and hence the content becomes 0.02 g/L or less in some cases. Therefore, it is preferable to incorporate excess metal ion into the titanium stripping solution beforehand or to supplement the metal ion suitably into the titanium stripping solution.

Examples of the metal ion having a reducing power include any ions of trivalent titanium or divalent iron and they can be incorporated singly or as any combination thereof.

Moreover, examples of the fluorine compound constituting the titanium stripping solution of the present invention include ammonium fluoride, sodium fluoride, potassium fluoride, acid sodium fluoride, acid potassium fluoride, hydrofluoric acid, sodium silicofluoride, hydrosilicofluoric acid, ammonium silicofluoride, potassium silicofluoride, hydroborofluoric acid, sodium borofluoride, potassium borofluoride, ammonium borofluoride, and the like. The content of such a fluorine compound in the titanium stripping solution can be set in the range of 1 to 270 g/L, preferably 1 to 180 g/L, more preferably 1 to 50 g/L in terms of fluorine. When the content of the fluorine compound is less than 1 g/L, the etching rate of titanium becomes low, and when it exceeds 270 g/L, the fluorine compound becomes in a saturated state in the titanium stripping solution, so that the cases are not preferable.

The titanium stripping solution of the present invention has pH 5 or lower, preferably pH 3 to 4. When the pH exceeds 5, etching of titanium is disturbed. The pH of the titanium stripping solution can be adjusted with, for example, sulfuric acid, hydrochloric acid, ammonia water, sodium hydroxide, potassium hydroxide, or the like.

Moreover, the titanium stripping solution of the present invention may optionally contain a metal corrosion inhibitor according to the environment in which the titanium thin film to be stripped is present and the purpose of use. For example, in the case that copper is used together with titanium as the metal constituting the UBM, the titanium stripping solution may contain a copper corrosion inhibitor. Examples of the copper corrosion inhibitor include benzotriazole, mercaptobenzothiazole, 1,2,4-triazole, and the like.

The titanium stripping solution of the present invention contains the metal ion having a reducing power together with the fluorine compound and, by adjusting the pH to the above range, the solution can remove the titanium thin film by etching with suppressing the corrosion of other metal(s) such as a solder alloy, tin, or the like to a low extent.

In the case that the titanium thin film is removed by etching using the titanium stripping solution as mentioned above, the temperature of the titanium stripping solution (treating bath) is not particularly limited but is preferably set at the range of 25 to 35° C., for example.

The following will describe the present invention in further detail with reference to specific Examples.

### EXAMPLE 1

(Preparation of Titanium Stripping Solutions)

Eight kinds of titanium stripping solutions (Samples 1 to 8) having the following compositions containing a trivalent titanium ion (Ti(III)) as a metal having a reducing power were prepared. But, the concentrations of Ti(III) were the eight kinds shown in the following Table 1 and the pH was set at 3.0 with ammonia water.

Composition of Titanium Stripping Solutions

Ammonium fluoride: 25 g/L (in terms of fluorine)
20% Aqueous solution of titanium(III) chloride: 0 to 10 g/L (in terms of Ti(III))
Benzotriazole: 1 g/L
Ion-exchange water: balance
   (Measurement of Etching Rate with Titanium Stripping Solutions)

A titanium thin film (thickness: 1800 Å) formed on a wafer by spattering was subjected to dip etching under the following conditions using each of the titanium stripping solutions (Samples 1 to 8) prepared as mentioned above. The time required for etching of the titanium thin film was measured and an etching rate was calculated (as an average of three times of measurements). The results are shown in the following Table 1.

Etching Conditions

Stirring rate: 300 rpm
Bath temperature: 25° C.
Bath volume: 100 mL
   (Evaluation on Corrosion-Suppressing Effect of Titanium Stripping Solutions)

Pb-free solder balls (diameter=0.76 mm) of tin-silver (Sn:Ag=96.5:3.5) and solder balls (diameter=0.76 mm) of tin-lead (Sn:Pb=63:37) were dipped under the following conditions in each of the titanium stripping solution (Samples 1 to 8) prepared as mentioned above and then taken out, and a degree of corrosion was visually observed according to the following standards. The results are shown in the following Table 1. In this connection, when the degree of corrosion was a state of Level 4 or Level 5, the sample was regarded as no corrosion and the case was judged that a corrosion-preventing effect was exhibited.

Dipping Conditions

Bath volume: 100 mL
Dipping time: 2 minutes
Bath temperature: 25° C.
Dipped pieces: 10 pieces
   Evaluation Standards

Level 5: A surface state of the tin-silver solder balls or tin-lead solder balls is the same as that before dipping in the titanium stripping solution.

Level 4: Corrosion is observed at part of the surface of the tin-silver solder balls or tin-lead solder balls, but surface gloss is about the same as that before dipping in the titanium stripping solution.

Level 3: Corrosion is observed at the whole surface of the tin-silver solder balls or tin-lead solder balls, and surface gloss is lower than that before dipping in the titanium stripping solution.

Level 2: Corrosion is observed at the whole surface of the tin-silver solder balls or tin-lead solder balls, and surface gloss is also lost.

Level 1: Irregularity is observed at the surface of the tin-silver solder balls or tin-lead solder balls, and the shape is collapsed.

TABLE 1

| Titanium | Ti(III) | | | |
|---|---|---|---|---|
| stripping | concentration | Etching rate | Level of corrosion state | |
| solution | (g/L) | (Å/minute) | Sn/Ag | Sn/Pb |
| Sample 1 | 0 | 3900 | 2 | 3 |
| Sample 2 | 0.01 | 3900 | 3 | 3 |
| Sample 3 | 0.02 | 3900 | 4 or more | 4 or more |
| Sample 4 | 0.05 | 4000 | 4 or more | 4 or more |
| Sample 5 | 0.10 | 3700 | 4 or more | 4 or more |
| Sample 6 | 1.0 | 3600 | 4 or more | 4 or more |
| Sample 7 | 5.0 | 4000 | 4 or more | 4 or more |
| Sample 8 | 10 | 4200 | 4 or more | 4 or more |

As shown in Table 1, it was confirmed that all the titanium stripping solutions (Samples 3 to 8) of the present invention having a Ti(III) concentration of 0.02 g/L or more exhibited a high etching rate and the corrosion of the tin-silver solder balls and tin-lead solder balls was also suppressed.

On the other hand, the titanium stripping solutions (Samples 1 and 2) having a Ti(III) concentration of less than 0.02 g/L exhibited a high etching rate but the corrosion of the tin-silver solder balls or tin-lead solder balls occurred, so that they were not applicable to practical use.

### EXAMPLE 2

(Preparation of Titanium Stripping Solutions)

Eight kinds of titanium stripping solutions (Samples 9 to 16) having the following compositions containing a divalent iron ion (Fe(II)) as a metal having a reducing power were prepared. But, the concentrations of Fe(II) were the eight kinds shown in the following Table 2 and the pH was set at 3.0 with ammonia water.

Composition of Titanium Stripping Solutions

Ammonium fluoride: 25 g/L (in terms of fluorine)
Iron(II) sulfate heptahydrate: 0 to 10 g/L (in terms of Fe(II))
Benzotriazole: 1 g/L
Ion-exchange water: balance
   (Measurement of Etching Rate with Titanium Stripping Solutions)

An etching rate was calculated under the same conditions as in Example 1. The results are shown in the following Table 2.

(Evaluation on Corrosion-Suppressing Effect of Titanium Stripping Solutions)

A degree of the corrosion of the tin-silver solder balls or tin-lead solder balls was observed under the same conditions as in Example 1. The results are shown in the following Table 2. In this connection, when the degree of the corrosion was a state of Level 4 or Level 5, the sample was regarded as no corrosion and the case was judged that a corrosion-preventing effect was exhibited.

TABLE 2

| Titanium | Fe(II) | | | |
|---|---|---|---|---|
| stripping | concentration | Etching rate | Level of corrosion state | |
| solution | (g/L) | (Å/minute) | Sn/Ag | Sn/Pb |
| Sample 9 | 0 | 3900 | 2 | 3 |
| Sample 10 | 0.01 | 3900 | 3 | 3 |
| Sample 11 | 0.02 | 4000 | 4 | 4 or more |
| Sample 12 | 0.05 | 4000 | 4 or more | 4 or more |
| Sample 13 | 0.10 | 4000 | 4 or more | 4 or more |
| Sample 14 | 1.0 | 4200 | 4 or more | 4 or more |
| Sample 15 | 5.0 | 4300 | 4 or more | 4 or more |
| Sample 16 | 10 | Formation of | 3 | 4 or more |
| | | precipitate/ | | |
| | | Impossible | | |
| | | to measure | | |

As shown in Table 2, it was confirmed that all the titanium stripping solutions (Samples 11 to 16) having an Fe(II) concentration of 0.02 g/L or more exhibited a high etching rate and the corrosion of the tin-silver solder balls and tin-lead solder balls was also suppressed.

On the other hand, the titanium stripping solutions (Samples 9 and 10) having an Fe(II) concentration of less than 0.02 g/L exhibited a high etching rate but the corrosion of the tin-silver solder balls or tin-lead solder balls occurred, so that they were not applicable to practical use.

### EXAMPLE 3

(Preparation of Titanium Stripping Solutions)

Eight kinds of titanium stripping solutions (Samples 17 to 24) having the following compositions containing a divalent titanium ion (Ti(III)) as a metal having a reducing power were prepared. But, the concentrations of Ti(III) were the eight kinds shown in the following Table 3 and the pH was set at 3.0 with ammonia water.

Composition of Titanium Stripping Solutions

Acid sodium fluoride: 5 g/L (in terms of fluorine)
20% Aqueous solution of titanium(III) chloride: 0 to 10 g/L (in terms of Ti(III))
Benzotriazole: 1 g/L
Ion-exchange water: balance
   (Measurement of Etching Rate with Titanium Stripping Solutions)

An etching rate was calculated under the same conditions as in Example 1. The results are shown in the following Table 3.

(Evaluation on Corrosion-Suppressing Effect of Titanium Stripping Solutions)

A degree of the corrosion of tin-silver solder balls or tin-lead solder balls was observed under the same conditions as in Example 1. The results are shown in the following Table 3. In this connection, when the degree of the corrosion was a state of Level 4 or Level 5, the sample was regarded as no corrosion and the case was judged that a corrosion-preventing effect was exhibited.

TABLE 3

| Titanium | Ti(III) | | | |
|---|---|---|---|---|
| stripping | concentration | Etching rate | Level of corrosion state | |
| solution | (g/L) | (Å/minute) | Sn/Ag | Sn/Pb |
| Sample 17 | 0 | 1600 | 2 | 3 |
| Sample 18 | 0.01 | 1600 | 3 | 4 |
| Sample 19 | 0.02 | 1600 | 4 | 4 or more |
| Sample 20 | 0.05 | 1700 | 4 or more | 4 or more |
| Sample 21 | 0.10 | 1500 | 4 or more | 4 or more |
| Sample 22 | 1.0 | 1600 | 4 or more | 4 or more |
| Sample 23 | 5.0 | 600 | 4 or more | 4 or more |
| Sample 24 | 10 | 400 | 4 or more | 4 or more |

As shown in Table 3, it was confirmed that all the titanium stripping solutions (Samples 19 to 24) having a Ti(III) concentration of 0.02 g/L or more exhibited a high etching rate and the corrosion of the tin-silver solder balls and tin-lead solder balls was also suppressed.

On the other hand, the titanium stripping solutions (Samples 17 and 18) having a Ti(III) concentration of less than 0.02 g/L exhibited a high etching rate but the corrosion of the tin-silver solder balls or tin-lead solder balls occurred, so that they were not applicable to practical use.

### EXAMPLE 4

(Preparation of Titanium Stripping Solutions)

Six kinds of titanium stripping solutions (Samples 25 to 30) having the following compositions containing a divalent titanium ion (Ti(III)) as a metal having a reducing power were prepared. But, the pH's were set at six kinds, i.e., 3, 4, 5, 6, 7, and 8 with ammonia water.

Composition of Titanium Stripping Solutions

Ammonium fluoride: 25 g/L (in terms of fluorine)
20% Aqueous solution of titanium(III) chloride: 0.05 g/L (in terms of Ti(III))
Benzotriazole: 1 g/L
Ion-exchange water: balance
   (Measurement of Etching Rate with Titanium Stripping Solutions)

An etching rate was calculated under the same conditions as in Example 1. The results are shown in the following Table 4.

(Evaluation on Corrosion-Suppressing Effect of Titanium Stripping Solutions)

A degree of the corrosion of tin-silver solder balls or tin-lead solder balls was observed under the same conditions as in Example 1. The results are shown in the following Table 4. In this connection, when the degree of the corrosion was a state of Level 4 or Level 5, the sample was regarded as no corrosion and the case was judged that a corrosion-preventing effect was exhibited.

TABLE 4

| Titanium | | | | |
|---|---|---|---|---|
| stripping | | Etching rate | Level of corrosion state | |
| solution | Bath pH | (Å/minute) | Sn/Ag | Sn/Pb |
| Sample 25 | 3 | 3000 | 4 or more | 4 or more |
| Sample 26 | 4 | 2000 | 4 or more | 4 or more |
| Sample 27 | 5 | 900 | 4 or more | 4 or more |
| Sample 28 | 6 | 100 or less | 4 or more | 4 or more |
| Sample 29 | 7 | — | — | — |
| Sample 30 | 8 | — | — | — |

As shown in Table 4, it was confirmed that all the titanium stripping solutions (Samples 25 to 27) having a pH of 5 or lower exhibited a high etching rate and the corrosion of the tin-silver solder balls and tin-lead solder balls was also suppressed.

On the other hand, the titanium stripping solutions (Samples 28 to 30) having a pH exceeding 5 suppress the corrosion of the tin-silver solder balls and tin-lead solder balls but the etching rate of titanium is low, so that they were not applicable to practical use.

1. A titanium stripping solution, which is an aqueous solution of pH 5 or lower containing a fluorine compound and a metal ion having a reducing power.

2. The titanium stripping solution according to claim 1, wherein the metal ion is any ion of trivalent titanium or divalent iron.

3. The titanium stripping solution according to claim 1, wherein the concentration of the metal ion is 0.02 g/L or more.

4. The titanium stripping solution according to claim 3, wherein the metal ion is any ion of trivalent titanium or divalent iron.

5. The titanium stripping solution according to claim 1, wherein the content of the fluorine compound is within the range of 1 to 270 g/L in terms of fluorine.

6. The titanium stripping solution according to claim 5, wherein the concentration of the metal ion is 0.02 g/L or more.

7. The titanium stripping solution according to claim 6, wherein the metal ion is any ion of trivalent titanium or divalent iron.

8. The titanium stripping solution according to claim 1, which further contains a copper corrosion inhibitor.

9. The titanium stripping solution according to claim 8, wherein the concentration of the metal ion is 0.02 g/L or more.

10. The titanium stripping solution according to claim 9, wherein the metal ion is any ion of trivalent titanium or divalent iron.

11. The titanium stripping solution according to claim 8, wherein the content of the fluorine compound is within the range of 1 to 270 g/L in terms of fluorine.

12. The titanium stripping solution according to claim 11, wherein the concentration of the metal ion is 0.02 g/L or more.

13. The titanium stripping solution according to claim 12, wherein the metal ion is any ion of trivalent titanium or divalent iron.
